(19) United States
(12) Patent Application Publication
(10) Pub. No.: US 2024/0362076 A1
(43) Pub. Date: Oct. 31, 2024

(54) SYSTEM FOR ADJUSTING CONTINUOUS CONTROL SENSITIVITY BASED ON OPTIMAL SEARCH AND METHOD THEREOF

(71) Applicant: DOOSAN ENERBILITY CO., LTD., Changwon (KR)

(72) Inventors: Jwa Young MAENG, Yongin (KR); Hyun Sik KIM, Gimpo (KR); Jun Woo YOO, Seoul (KR); Sang Gun NA, Seoul (KR)

(21) Appl. No.: 18/633,519

(22) Filed: Apr. 12, 2024

(30) Foreign Application Priority Data
Apr. 27, 2023 (KR) 10-2023-0055370

(51) Int. Cl. G06F 9/50; G05B 13/02

(52) U.S. Cl. CPC G06F 9/505; G05B 13/021

(57) ABSTRACT

The present disclosure relates to a system and method for adjusting control sensitivity based on optimal search. According to the present disclosure, stable control convergence can be achieved without excessively shortening the lifespan of a target device by moving a target device only when there is a control gain larger than or equal to a preset reference value. This occurs during continuous control of the target device through the system for adjusting a control sensitivity based on optimal search, which adjusts the sensitivity of the continuous control based on optimal search.

### CROSS-REFERENCE TO RELATED APPLICATION

This application claims under 35 U.S.C. § 119 (a) the benefit of priority to Korean Patent Application No. 10-2023-0055370 filed on Apr. 27, 2023, the entire contents of which are incorporated herein by reference.

### BACKGROUND

### Technical Field

The present disclosure relates to a system for adjusting a control sensitivity based on optimal search and a method thereof, and more specifically, to a system for adjusting a continuous control sensitivity based on optimal search and a method thereof, which adjust sensitivity to derive an optimal control value that is used to control a target device, taking into account a previous control value with optimal search in every cycle.

### Background Art

Mathematical optimization methods, such as single agent optimization, swarm-based optimization, and particle swarm optimization (PSO), are used to derive optimal control values. The mathematical optimization is a technique for finding a value that minimizes or maximizes an objective function f(x), among given candidates.

When deriving the optimal control values using such mathematical optimization techniques, a value for the manipulated variable (MV) that optimizes the objective function is derived in each cycle. In particular, in instances where constraint conditions are satisfied, control values are derived even with minor improvement in the evaluation of the objective function, such as a change or improvement of 0.00001. This can lead to shortened lifespan of a target device due to an excessive movement of the target device without a large control gain, or cause the control to diverge.

### SUMMARY OF THE DISCLOSURE

The present disclosure is directed to providing a system for adjusting a continuous control sensitivity based on optimal search and method thereof, which adjust sensitivity to derive an optimum point in consideration of a previous control value upon optimal search in every cycle.

A system for adjusting continuous control sensitivity based on optimal search for achieving the object may include a task manager determining at least one manipulated variable; a search space manager determining a search space of the at least one manipulated variable; an optimization explorer calculating a control size and a control fare using a current value of a manipulated variable of the at least one manipulated variable and a changed value of the manipulated variable, and searching for an optimal control value corresponding to the manipulated variable using the control fare comprising a base fare and a distance fare; and an output controller controlling an operation of the target device based on the optimal control value by selectively applying the optimal control value to the target device.

The optimization explorer may include a control fare imposer calculating the control size and the control fare, wherein the control fare is a sum of the base fare and the control fare; and a load detector detecting a load of the system for adjusting the control sensitivity and updating the base fare and the distance fare according to the detected load of the system for adjusting the control sensitivity.

The control fare imposer may include a control size calculator calculating the control size by calculating a distance between the current value of the manipulated variable and the changed value of the manipulated variable; a base fare imposer determining the base fare according to the number of times a control of the target device is performed; and a distance fare imposer determining the distance fare in proportion to the distance between the current value of the manipulated variable and the changed value of the manipulated variable based on the control size.

The control fare imposer may determine the control fare through the Equation below when a value of the manipulated variable is changed,

$$Control\_Fare = Base\_Fare + Distance\_Fare$$

$$Distance\_Fare = Distance\_Ratio \times Control\_Size$$

$$Control\_Size = \sqrt[2]{\sum \{ {( M {V}_{changed} - M {V}_{current} )}^{2} \}}$$

where, the Control Fare denotes the control fare determined according to a change in the manipulated variable, the Base Fare denotes the base fare determined based on the number of times a control of the target device is performed, the Distance_Fare denotes the distance fare determined in proportion to the control size, the Distance_Ratio denotes a preset fare per control size, the Control_Size denotes the control size, the MV_{changed} denotes the changed value of the manipulated variable, and the MV_{current} denotes the current value of the manipulated variable.

The load detector may increase the base fare and the distance fare when the detected load of the system for adjusting the control sensitivity is larger than a preset reference value.

The load detector may decrease the base fare and the distance fare when the detected load of the system for adjusting the control sensitivity is smaller than or equal to a preset reference value.

According to the present disclosure, there is provided a method for adjusting control sensitivity of a target device based on an optimal search performed by a computing system comprising a processor and a memory, wherein the memory stores instructions which, when executed by the processor, enable the computing system to perform operations including: determining at least one manipulated variable; determining a search space of the at least one manipulated variable; calculating a control size and a control fare using a current value of a manipulated variable of the at least one manipulated variable and a changed value of the manipulated variable, and searching for an optimal control value corresponding to the manipulated variable using the control fare comprising a base fare and a distance fare; and controlling an operation of the target device based on the optimal control value by selectively applying the optimal control value to the target device.

As described above, according to the present disclosure, by moving the target device only when there is the control gain larger than or equal to the preset reference value during continuous control, aimed at adjusting the sensitivity based on optimal search, it is possible to achieve stable control convergence without excessively shortening the lifetime of the target device. In addition, by improving the reliability of the control system, it is possible to increase the competitiveness of the product.

### BRIEF DESCRIPTION OF THE DRAWINGS

FIG. 1 is a configuration diagram of a system for adjusting continuous control sensitivity based on optimal search according to one embodiment of the present disclosure.

FIG. 2 is a configuration diagram of a control fare imposer according to one embodiment of the present disclosure.

FIG. 3 is an exemplary view for describing a distance fare imposer according to one embodiment of the present disclosure.

FIG. 4 is an exemplary view for comparing the control fare imposer according to one embodiment of the present disclosure with a conventional system in the related art.

FIG. 5 is a comparison diagram for comparing optimal control values searched by an optimization explorer with control values searched by the related art according to one embodiment of the present disclosure.

FIG. 6 is a flowchart of a method of adjusting continuous control sensitivity based on optimal search according to another embodiment of the present disclosure.

FIG. 7 illustrates an example block diagram of a computing device suitable for implementing any of the various embodiments of the present disclosure.

### DETAILED DESCRIPTION

Hereinafter, exemplary embodiments according to the present disclosure will be described in detail with reference to the accompanying drawings. In this process, thicknesses of lines, sizes of components, or the like illustrated in the drawings may be exaggerated for clarity and convenience of description.

Throughout the specification, when a certain portion is described as “including” a certain element, it means that the certain portion may further include other elements rather than precluding other elements unless specifically stated to the contrary.

In addition, terms to be described below are the terms defined in consideration of functions in the present disclosure, which may vary depending on the intention or custom of a user or an operator. Therefore, the definition of these terms should be made based on the contents throughout the specification.

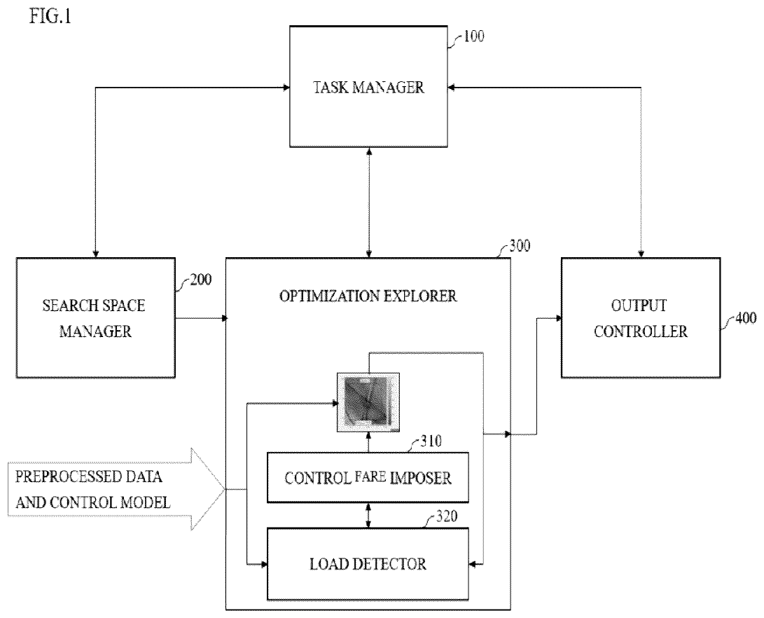

FIG. 1 is a configuration diagram of a system for adjusting continuous control sensitivity based on optimal search according to one embodiment of the present disclosure.

As illustrated in FIG. 1, the system for adjusting the continuous control sensitivity based on optimal search according to one embodiment of the present disclosure may include a task manager 100, a search space manager 200, an optimization explorer 300, and an output controller 400.

Specifically, the task manager 100 may determine at least one manipulated variable (MV) and transmit the specified MV(s) to a designated module, component, or the like. Here, the MV is a variable manipulated by the system for adjusting the continuous control sensitivity based on optimal search according to a preset process.

Next, the search space manager 200 may set a search space for the at least one MV. In this case, the search space may be set within a preset limit range in each of upper and lower halves for each MV transmitted from the task manager 100.

Next, the optimization explorer 300 may calculate a control size and control fare using a current MV value and a changed MV value, and search for an optimal control value corresponding to the manipulated variable using the control fare comprising a base fare and a distance fare. Here, the optimization explorer 300 may search for an optimal control value within the search space set by the search space manager 200.

Specifically, the optimization explorer 300 may search for the optimal control value in consideration of an objective function value, the control size, and the control fare each time the MV is manipulated.

In addition, the optimization explorer 300 may receive the changed MV value from preprocessed data and a control model.

In addition, the optimization explorer 300 may include a control fare imposer 310 and a load detector 320.

First, the control fare imposer 310 may calculate the control size and determine a control fare which is the sum of a base fare and a distance fare, wherein the distance fare is calculated through the current MV value and the changed MV value.

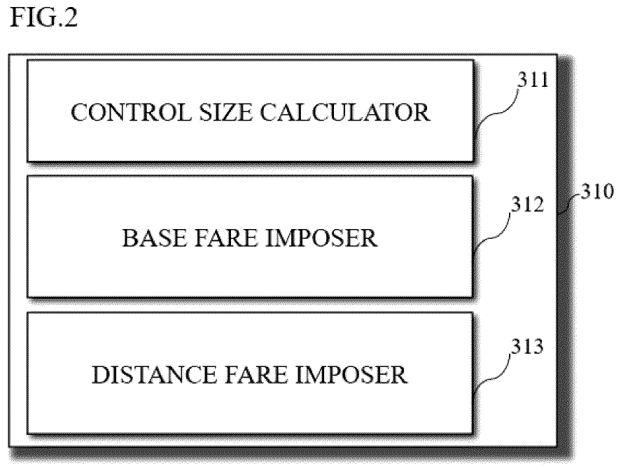

FIG. 2 is a configuration diagram of the control fare imposer according to one embodiment of the present disclosure.

As illustrated in FIG. 2, the control fare imposer 310 may include a control size calculator 311, a base fare imposer 312, and a distance fare imposer 313.

The control adjustment size calculator 311 may calculate the control size by calculating a distance between the current MV value and the changed MV value. Here, the current MV value indicates a current control value applied to a target device, and the changed MV value indicates a control value after the current MV is changed.

The base fare imposer 312 may determine a preset base fare according to the number of times a control corresponding to a target device is performed. The control may refer to a control operation such as those carried out by an actuator, but is not limited to these operations, and any mechanism that controls a device may be included. The distance fare imposer 313 may determine a distance fare based on the calculated control size. Specifically, the distance fare imposer 313 may determine a distance fare proportional to the control size. Here, the control size indicates the distance between the current MV value and the changed MV value and may be an Euclidean distance.

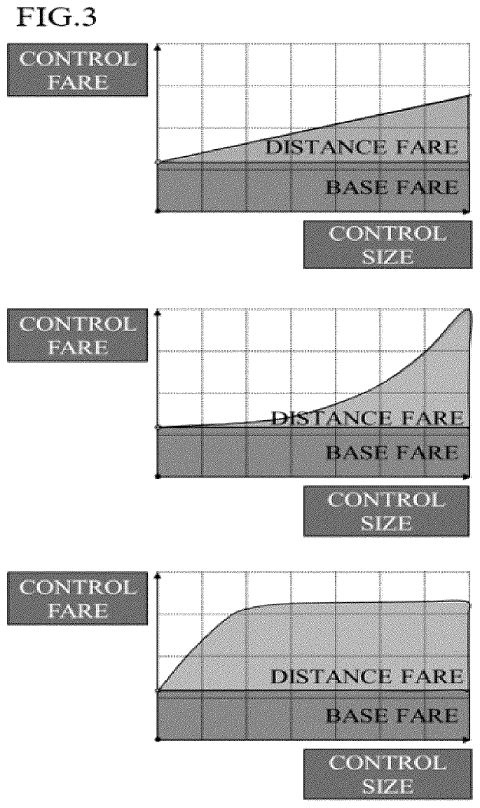

FIG. 3 is an exemplary view for describing the distance fare imposer according to one embodiment of the present disclosure.

As illustrated in FIG. 3, the distance fare imposer 313 may determine a distance fare that is either linearly or non-linearly proportional depending on the distance between the current MV value and the changed MV value.

As an example, when the distance fare is linearly proportional to the distance between the current MV value and the changed MV value, the control fare imposer 310 may calculate the control fare when a value of the MV is changed through Equation 1 below.

$$Control\_Fare = Base\_Fare + Distance\_Fare \qquad [ Equation 1 ]$$

$$Distance\_Fare = Distance\_Ratio \times Control\_Size$$

$$Control\_Size = \sqrt[2]{\sum \{ {( M {V}_{changed} - M {V}_{current} )}^{2} \}}$$

Here, the Control_Fare denotes the control fare determined according to a change in the MV, the Base_Fare denotes a preset base fare determined based on the number of times a control of the target device is performed, the Distance_Fare denotes the distance fare determined in proportion to the control size which is the distance between the current MV value and the changed MV value, the Distance_Ratio denotes a preset fare per the control size, the Control_Size denotes the control size, MV_{changed} denotes the changed MV value, and MV_{current} denotes the current MV value.

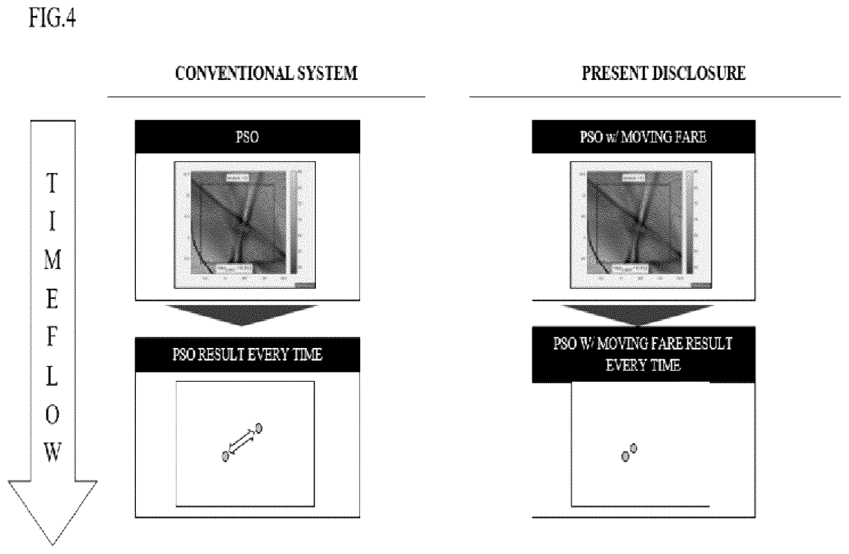

FIG. 4 is an exemplary view for comparing the control fare imposer according to one embodiment of the present disclosure with a conventional system in the related art.

As illustrated in FIG. 4, the related art does not consider the cost of control adjustment, leading to a limitation where the lifetime of a target device (e.g., actuator) is shortened by frequent control adjustments. Moreover, it derives the optimal control value for even minor improvements (e.g., 0.0001) without considering the distance between the current MV value and the changed MV value in each cycle, resulting in frequent control adjustments.

On the other hand, according to the embodiment of the present disclosure, by charging the base fare each time the control variable is changed from the current MV value and imposing the distance fare depending on the distance between the current MV value and the changed MV value, the system is able to derive the control value in consideration of a degree of control improvement and the control size, thereby preventing the unnecessary shortening of the lifetime of the target device, such as an actuator.

Next, the load detector 320 may detect a load of the system for adjusting the control sensitivity and adjust the base fare and the distance fare according to the detected load of the system for adjusting the control sensitivity.

In other words, the load detector 320 may increase the base fare and the distance fare when the detected load of the system for adjusting the control sensitivity is larger than a preset reference value. Here, when the load of the system for adjusting the control sensitivity exceeds the preset reference value, it indicates a non-converged control state, characterized by control value divergence, excessive movement instead of control improvement, or continuous need for minute control adjustments.

In addition, the load detector 320 may decrease the base fare and the distance fare to a real number larger than zero when the detected load of the system for adjusting the control sensitivity is smaller than or equal to the same or a different preset reference value.

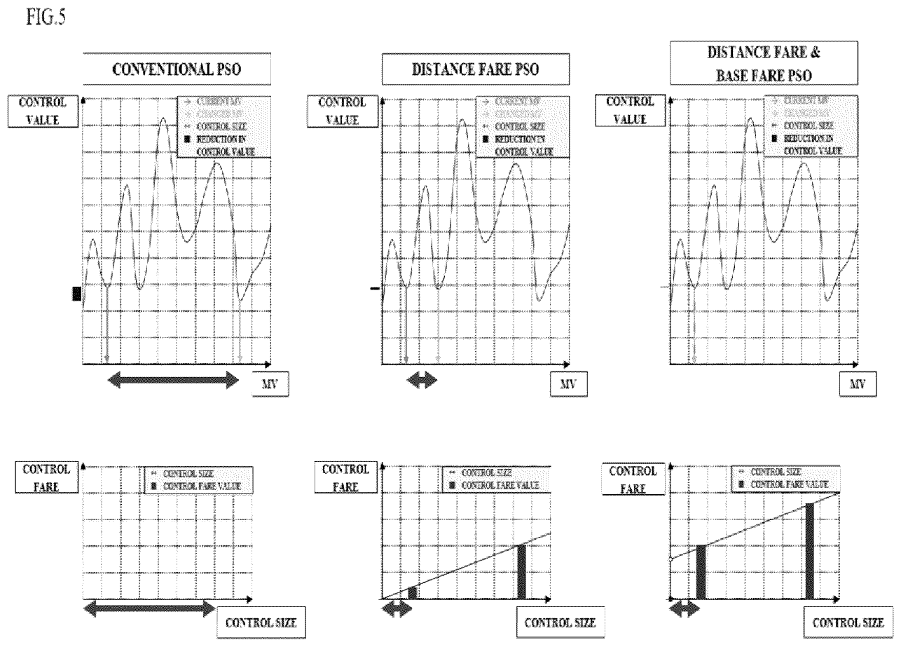

FIG. 5 is a comparison diagram for comparing optimal control values searched by an optimization explorer with control values searched by the related art according to one embodiment of the present disclosure.

As illustrated in FIG. 5, conventionally, the MV was adjusted to a point where the control value is minimized without considering the size of the control adjustment resulting in frequent small control adjustments. Additionally, when only the size of the control adjustment was considered without using the base fare, the MV was adjusted to a point with a small control adjustment size. This approach can lead to a reduction in lifespan of the target device (e.g. actuator) due to control adjustments made for minor improvements.

On the other hand, in the case of the control value searched by the optimization explorer according to one embodiment of the present disclosure, since the control value is searched in consideration of the base fare determined each time the MV is changed and the distance fare determined in proportion to the distance between the current MV value and the changed MV value, it is possible to prevent a reduction in the lifetime of the target device (e.g., actuator) accordingly. In addition, the optimization explorer 300 may have an optimization mode therein.

In the optimization mode, the optimization explorer 300 may search for the optimal control value by changing each term of the objective function to a preset term or by changing a weight coefficient multiplied by each term to a preset value.

In this case, when the changed weight coefficient is “0”, a term by which the changed weight coefficient is multiplied may not affect a final output through the objective function. In addition, when the changed coefficient value is not “0”, the influence on the final output through the objective function of each term may be adjusted depending on the size of the changed weight coefficient.

For example, in the case of combustion optimization of a thermal power generation boiler, the output controller 400 may convert the optimal control value and transmit the converted optimal control value to a target according to a mode such as “balanced mode,” “pollutant minimization mode,” “device protection mode,” or “custom mode.” Here, “balanced mode” has terms related to a reduction in operating costs, efficiency maximization, pollutant minimization, and equipment protection, and each term may have a different or identical weight coefficient.

In addition, in the “pollutant minimization mode,” the optimization explorer 300 may search for the optimal control value that prioritizes pollutant reduction by increasing the weight coefficient of the term related to pollutants by a preset ratio and decreasing the weight coefficient of the term not related to the pollutants by the same or a different preset ratio, within the objective function of “balanced mode”.

In addition, in the “device protection mode,” the optimization explorer 300 may search for the optimal control value that prioritizes the device protection by increasing the weight coefficient of the term related to a reduction in temperature lateral deviation, NOx lateral deviation, steam lateral deviation, or the like of combustion gas by a preset ratio and decreasing the weight coefficient of the term not related to the reduction in temperature lateral deviation, NOx lateral deviation, steam lateral deviation, or the like of the combustion gas by the same or a different preset ratio.

In addition, in the “custom mode”, the optimization explorer 300 can decrease or minimize a weight coefficient of a term except for the term corresponding to the user's purpose by a preset ratio in the objective function according to the user's input signal.

As an example, when the user maximally decreases only the generation of “NOx” among pollutants, the optimization explorer 300 may set the weight coefficient of the term not related to the generation of NOx to “0” or a preset value (e.g., 0.001).

Next, the output controller 400 may control the final output of the system for adjusting the control sensitivity by applying the transmitted optimal control value according to the MV. Additionally, the output controller 400 may control an operation of the target device based on the optimal control value by selectively applying the optimal control value to the target device.

Specifically, the output controller 400 may convert the optimal control value transmitted from the optimization explorer 300 according to a safety logic or control mode, and transmit the converted optimal control value to the target device in order to control the operation of the target device. Here, the control mode may include “an open loop control mode” (or “STOP”) in which the output controller 400 collects only data of the target device without transmitting the optimal control value to the target device, “a guide mode” in which the output controller 400 displays the optimal control value to the user, and “a closed loop control mode” (or “RUN”) in which the output controller 400 transmits and immediately applies the optimal control value to the target device.

In the “closed loop control mode,” the output controller 400 may transmit only the optimal control value to the target device, while ensuring that the optimal control value remains in a stably controlled state through the use of a preset logic (e.g., a safety logic). At this time, the output controller 400 may divide the optimal control value by a predetermined number of times and apply it, or distribute and apply the optimal control value to the target device using a predetermined logic (for example, Model Predictive Control logic). With each transmission, it can deliver an optimal control value that has been converted, taking into account the target device and time.

As an example, in case in which a control value (e.g., a set value (SV) or a process value (PV)) of an air damper opening is 23%, and the optimization explorer 300 derives an optimal control value of 56%, the safety logic has the capability to determine whether the current control value of the air damper opening can be set to 56%.

If the safety logic determines that setting the control value to 56% is feasible, and given that the value can be stably controlled with an increase of 10% every 10 seconds, the output controller 400 may then transmit SV values of ‘33%’ for the first 10 seconds, ‘43%’ for the next 11 to 20 seconds, ‘53%’ for 21 to 30 seconds, and finally ‘56%’ for 31 to 40 seconds.

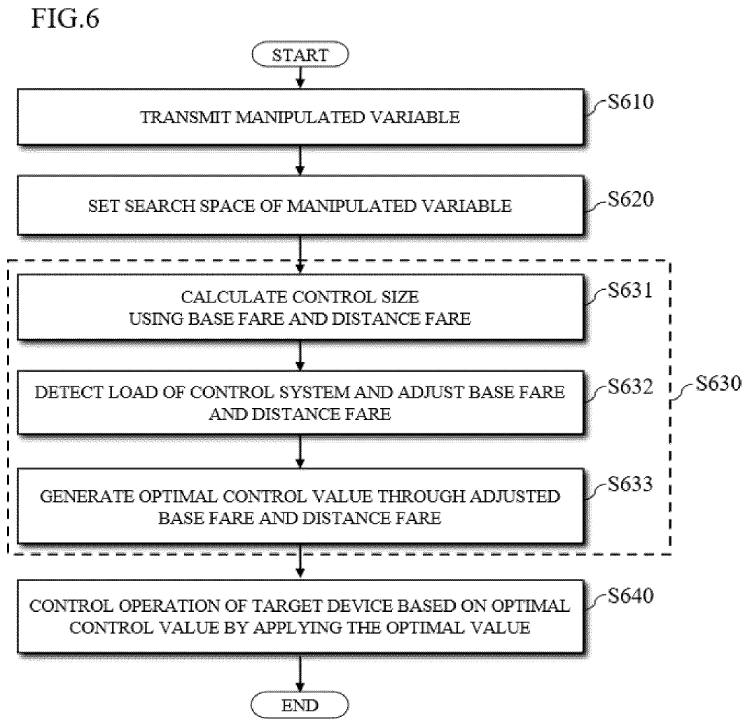

FIG. 6 is a flowchart of a method of adjusting continuous control sensitivity based on optimal search according to another embodiment of the present disclosure.

As illustrated in FIG. 6, in step S610, the task manager 100 may specify at least one MV and transmit the specified MV(s) to a designated component, module or the like. Here, the MV is a variable manipulated by the system for adjusting the continuous control sensitivity based on optimal search according to a preset process.

Next, in step S620, the search space manager 200 may set a search space for the at least one received MV. In this case, the search space may be set within a preset limit range in each of upper and lower halves for each MV transmitted from the task manager 100.

Next, the optimization explorer 300 may calculate the control size and the control fare using the current MV value and the changed MV value, and search for the optimal control value corresponding to the manipulated variable using the control fare comprising a base fare and a distance fare (S630).

Specifically, in step S631, the control fare imposer 310 may calculate the control fare which is the sum of the base fare and the distance fare, and the control size which is calculated through the current MV value and the changed MV value.

Next, in step S632, the load detector 320 may detect the load of the system for adjusting the control sensitivity and adjust the base fare and the distance fare according to the detected load of the system for adjusting the control sensitivity.

Next, in step S633, the optimization explorer 300 may search for the optimal control value through the adjusted base fare and the adjusted distance fare.

Lastly, in step S640, the output controller 400 may control the final output of the system for adjusting the control sensitivity by applying the searched optimal control value according to the MV. Additionally, the output controller 400 may control an operation of the target device based on the optimal control value by selectively applying the optimal control value to the target device.

Since specific contents in which each operation is performed are the same as those described with reference to FIGS. 1 to 5, overlapping descriptions will be omitted.

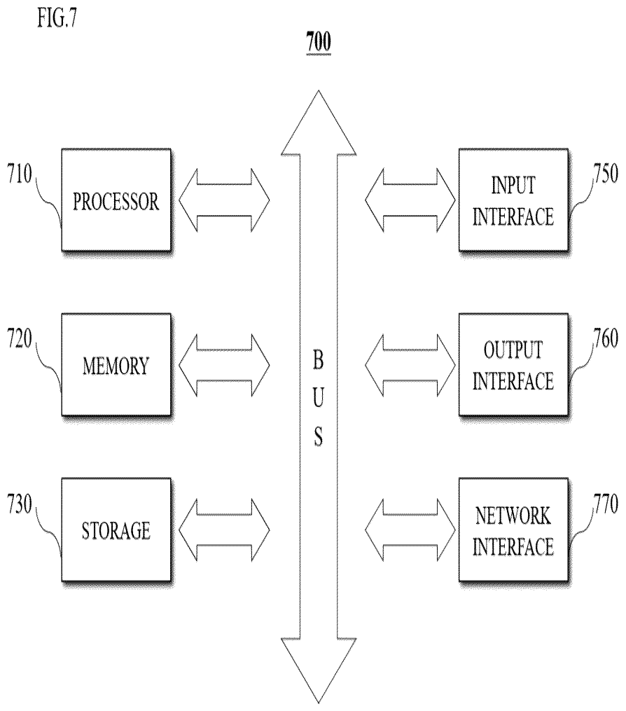

FIG. 7 illustrates an example block diagram of a computing device 700 suitable for implementing any of the various embodiments of the present disclosure. The computing device 700 is equipped with a processor 710, which may encompass multiple processors, cores, and/or support multithreading capabilities. Additionally, the device includes memory 720, which may consist of various types of RAM such as cache, SRAM, DRAM, eDRAM, etc. A bus 740 may facilitate communication within the computing device 700 and may conform to standards like PCI, ISA, or PCI-Express. The computing device 700 is also furnished with a network interface 770, capable of both wireless (e.g., WLAN, Bluetooth®) and wired (e.g., Ethernet) connections. The computing device 700 may support multiple network interfaces, each designed to connect the device to different communication networks. The computing device 700 may also include a variety of components or modules providing specific functionality, and these components or modules may be implemented in software, hardware, or a combination thereof. For example, the processor 710 may be configured to execute task manger 100, search space manager 200, optimization explorer 300, and output controller 400 by software; hardware; firmware; some combination of software, hardware, and/or firmware; As another example, the processor 710 may execute instructions stored in the memory 720 or storage 730 to implement various embodiments of the present disclosure. Furthermore, the input interface 750 and the output interface 760 may be configured to seamlessly facilitate the transmission and reception of diverse data formats between the computing device 700 and an external device. In FIG. 7, the components are shown as being on a single computing device, but the components may be distributed among multiple computing devices. The computing device 700 may be integrated into the external device. The computing device 700 may also include any input and output components, such as displays, speaker, keyboards, and touch screens.

According to the embodiment of the present disclosure, by moving the target device only when there is the control gain larger than or equal to the preset reference value during continuous control, aimed at adjusting the sensitivity based on optimal search, it is possible to achieve stable control convergence without excessively shortening the lifetime of the target device. In addition, by improving the reliability of the control system, it is possible to increase the competitiveness of the product.

Although the present disclosure has been described with reference to embodiments illustrated in the accompanying drawings, it is merely illustrative, and those skilled in the art to which the corresponding technology pertains will understand that various modifications and equivalent other embodiments are possible. Therefore, the true technical scope of the present disclosure should be determined by the technical spirit of the appended claims.

What is claimed is:

1. A system for adjusting a control sensitivity of a target device based on an optimal search, comprising:
a task manager determining at least one manipulated variable;
a search space manager determining a search space of the at least one manipulated variable;
an optimization explorer calculating a control size and a control fare using a current value of a manipulated variable of the at least one manipulated variable and a changed value of the manipulated variable, and searching for an optimal control value corresponding to the manipulated variable using the control fare comprising a base fare and a distance fare; and
an output controller controlling an operation of the target device based on the optimal control value by selectively applying the optimal control value to the target device.

2. The system of claim 1, wherein the optimization explorer includes:
a control fare imposer calculating the control size and the control fare, wherein the control fare is a sum of the base fare and the control fare; and
a load detector detecting a load of the system for adjusting the control sensitivity and updating the base fare and the distance fare according to the detected load of the system for adjusting the control sensitivity.

3. The system of claim 2, wherein the control fare imposer includes:
a control size calculator calculating the control size by calculating a distance between the current value of the manipulated variable and the changed value of the manipulated variable;
a base fare imposer determining the base fare according to the number of times a control of the target device is performed; and
a distance fare imposer determining the distance fare in proportion to the control size.

4. The system of claim 2, wherein the control fare imposer determines the control fare through the Equation below when a value of the manipulated variable is changed,
$$Control\_Fare = Base\_Fare + Distance\_Fare$$
$$Distance\_Fare = Distance\_Ratio \times Control\_Size$$
$$Control\_Size = \sqrt[2]{\sum \{ {( M {V}_{changed} - M {V}_{current} )}^{2} \}}$$
where, the Control_Fare denotes the control fare determined according to a change in the manipulated variable, the Base Fare denotes the base fare determined based on the number of times a control of the target device is performed, the Distance_Fare denotes the distance fare determined in proportion to the control size, the Distance_Ratio denotes a preset fare per the control size, the Control_Size denotes the control size, the MV_{changed} denotes the changed value of the manipulated variable, and the MV_{current} denotes the current value of the manipulated variable.

5. The system of claim 2, wherein the load detector increases the base fare and the distance fare when the detected load of the system for adjusting the control sensitivity is larger than a preset reference value.

6. The system of claim 2, wherein the load detector decreases the base fare and the distance fare when the detected load of the system for adjusting the control sensitivity is smaller than or equal to a preset reference value.

7. A method for adjusting a control sensitivity of a target device based on an optimal search performed by a computing system comprising a processor and a memory, wherein the memory stores instructions which, when executed by the processor, enable the computing system to perform operations including:
determining at least one manipulated variable;
determining a search space of the at least one manipulated variable;
calculating a control size and a control fare using a current value of a manipulated variable of the at least one manipulated variable and a changed value of the manipulated variable, and searching for an optimal control value corresponding to the manipulated variable using the control fare comprising a base fare and a distance fare; and
controlling an operation of the target device based on the optimal control value by selectively applying the optimal control value to the target device.

8. The method of claim 7, wherein the calculating of the control size and the control fare further includes:
calculating the control fare based on a sum of the base fare and the control fare; and
detecting a load of the computing system and updating the base fare and the distance fare according to the detected load of the computing system.

9. The method of claim 8, wherein the calculating of the control fare further includes:
calculating the control size by calculating a distance between the current value of the manipulated variable and the changed value of the manipulated variable;
determining the base fare according to the number of times a control of the target device is performed; and
determining the distance fare in proportion to the control size.

10. The method of claim 8, wherein the control fare is determined through the Equation below when a value of the manipulated variable is changed,
$$Control\_Fare = Base\_Fare + Distance\_Fare$$
$$Distance\_Fare = Distance\_Ratio \times Control\_Size$$
$$Control\_Size = \sqrt[2]{\sum \{ {( M {V}_{changed} - M {V}_{current} )}^{2} \}}$$
where, the Control_Fare denotes the control fare determined according to a change in the manipulated variable, the Base Fare denotes the base fare determined based on the number of times a control of the target device is performed, the Distance_Fare denotes the distance fare determined in proportion to the control size, the Distance_Ratio denotes a preset fare per the control size, the Control_Size denotes the control size, the MV_{changed} denotes the changed value of the manipulated variable, and the MV_{current} denotes the current value of the manipulated variable.

11. The method of claim 8, wherein the base fare and the distance fare are increased when the load of the computing system is larger than a preset reference value.

12. The method of claim 8, wherein the base fare and the distance fare are decreased when the load of the computing system is smaller than or equal to a preset reference value.
